(19) United States
(12) Patent Application Publication
(10) Pub. No.: US 2022/0164836 A1
(43) Pub. Date: May 26, 2022

(54) METHODS AND SYSTEMS AN OBV BUYBACK PROGRAM

(71) Applicant: SANDEEP AGGARWAL, GURGAON (IN)

(72) Inventor: SANDEEP AGGARWAL, GURGAON (IN)

(21) Appl. No.: 17/510,395

(22) Filed: Oct. 26, 2021

Related U.S. Application Data
(63) Continuation-in-part of application No. 17/033,890, filed on Sep. 27, 2020, now abandoned.
(60) Provisional application No. 62/906,098, filed on Sep. 26, 2019.

(51) Int. Cl. G06Q 30/02; G06Q 40/08

(52) U.S. Cl. CPC G06Q 30/0283; G06Q 40/08

(57) ABSTRACT

A method for implementing a token transfer feature on an online vehicle sales platform comprising: implementing a vehicle benchmarking; implementing a future price calculation based on OBV Algorithm based on benchmarked vehicle; calculating the risk factor based on the following parameters: vehicle segment performance, competition space and future launches, probability of the vehicle model being discontinued, impact of policy changes on the vehicle, and performance of OEMs; utilizing the risk factor and the vehicle benchmarking to calculate a Buyback Value to be offered.

### CLAIM OF PRIORITY

This application claim priority to and is a continuation in party of U.S. patent application Ser. No. 17/033,890, filed on Sep. 27, 2020, and titled METHODS AND SYSTEMS FOR CREDIT RISK ASSESSMENT FOR USED VEHICLE FINANCING. U.S. patent application Ser. No. 17/033,890 claims priority to U.S. Provisional Patent Application No. 62/906,098, filed on Sep. 26, 2019, and titled CREDIT RISK ASSESSMENT FOR USED VEHICLE FINANCING. U.S. patent application Ser. No. 17/033,890 claims priority to U.S. Provisional Patent Application No. 62/906,099, filed on Sep. 26, 2019, and titled AUTOMATED DEALS EVALUATION AND MANAGEMENT PLATFORM. These applications are hereby incorporate by reference in their entirety.

### BACKGROUND

Generally, when someone wishes to purchase a used vehicle (e.g. an automobile, etc.), the user can seek the lowest price. Additionally, when selling a used vehicle, the user can seek the highest price possible. It is also a common scenario that when someone is buying a used automobile from an individual seller, the buyer can acquire the used vehicle at a much lower price than buying from an automobile dealer considering the profit margin of the dealer in the transitional transaction. Similarly, when a user is selling a used vehicle, the used vehicle can fetch a better value when the sale is made to an individual buyer than an automobile dealer as the automobile dealer would try and acquire the vehicle at a lower price and add his/her profit margin during the transitional sale. However, individual users may not have the information to maximize their quoted prices to offer their used vehicle at. Additionally, a buying non-professional user may not have sufficient information to determine a reasonable price to purchase a used vehicle.

### SUMMARY OF THE INVENTION

A method for implementing a token transfer feature on an online vehicle sales platform comprising: implementing a vehicle benchmarking; implementing a future price calculation based on OBV Algorithm based on benchmarked vehicle; calculating the risk factor based on the following parameters: vehicle segment performance, competition space and future launches, probability of the vehicle model being discontinued, impact of policy changes on the vehicle, and performance of OEMs; utilizing the risk factor and the vehicle benchmarking to calculate a Buyback Value to be offered.

### BRIEF DESCRIPTION OF THE DRAWINGS

FIG. 1 illustrates an example process for calculation of an OBV Buyback Price, according to some embodiments.

FIG. 2 illustrates an example process for calculating the premium to be charged, according to some embodiments.

FIG. 3 illustrates an example process for benchmarking a new vehicle, according to some embodiments.

FIG. 4 illustrates an example process for calculating a risk premium, according to some embodiments.

FIG. 5 is a block diagram of a sample computing environment that can be utilized to implement various embodiments.

The Figures described above are a representative set and are not an exhaustive with respect to embodying the invention.

### DESCRIPTION

Disclosed are a system, method, and article of manufacture for an OBV buyback program. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment;’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment;’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alio: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression, and other tasks, which operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Monte Carlo experiments/simulations are a broad class of computational algorithms that rely on repeated random sampling to obtain numerical results. The underlying concept is to use randomness to solve problems that might be deterministic in principle. They are often used in physical and mathematical problems and are most useful when it is difficult or impossible to use other approaches. Monte Carlo methods can be used in three problem classes, inter alia: optimization, numerical integration, and generating draws from a probability distribution.

Orange Book Value (OBV) can be a market value prices for new and used automobiles of all types, as well as motorcycles. Additional discussions of OBV are provided infra.

Weighted average is the average of values which are scaled by importance. The weighted average of values is the sum of weights times values divided by the sum of the weights.

Example Methods and Systems

OBV Buyback is a program offered by an online vehicle marketplace to assure the buyers that in the future (e.g. 3 years from a present time period) they will be able to sell a vehicle at buyback price subjected to certain terms and conditions. This guarantee can be availed through presenting the certificate which is rendered at the time of the purchase of new/used vehicle on the online vehicle marketplace and/or partners of the online vehicle marketplace.

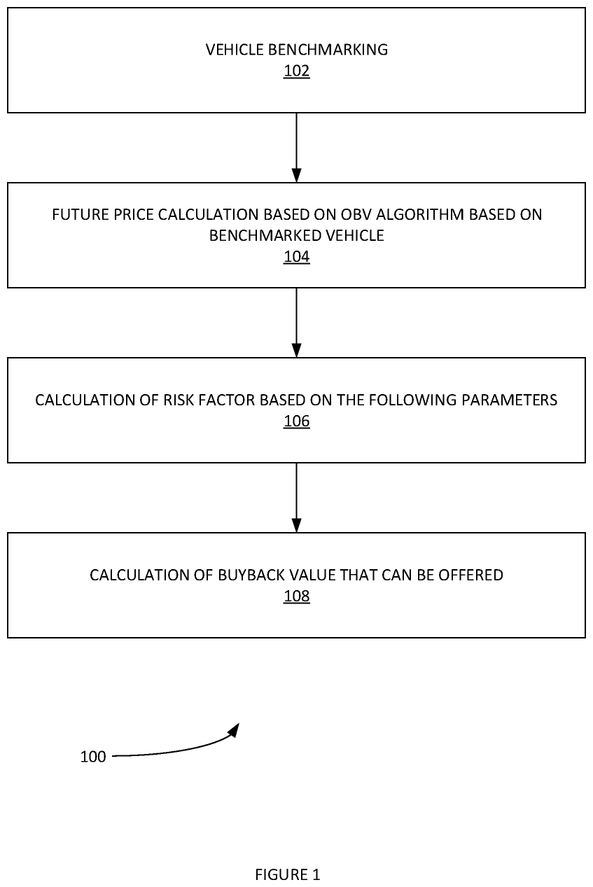

FIG. 1 illustrates an example process 100 for calculation of an OBV Buyback Price, according to some embodiments. In step 102, process 100 can implement vehicle benchmarking. For an existing vehicle (e.g. the vehicle exists in the market), the vehicle is benchmarked against the same vehicle in the market for previous years.

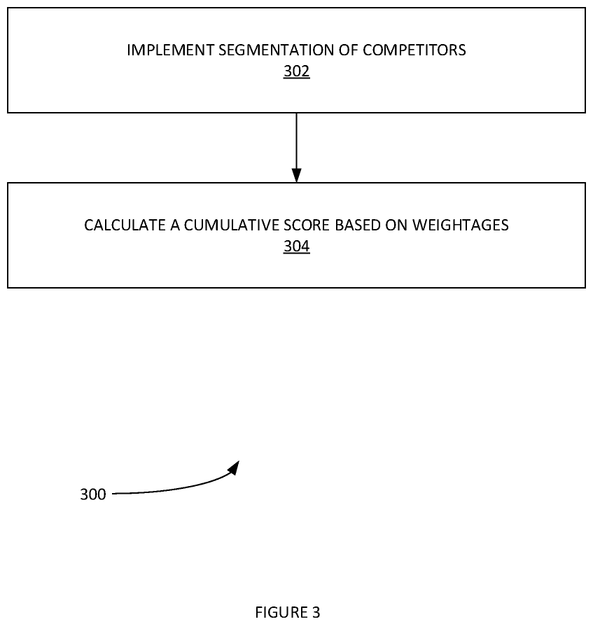

For a new vehicle, the follow steps can be implemented. FIG. 3 illustrates an example process for benchmarking a new vehicle, according to some embodiments. In step 302, process 300 can implement segmentation of competitors. In step 304, process 300 can calculate a cumulative score based on weightages of, inter alia: performance rating (A); safety rating (B); value for money rating (C); demand rating (D); Service Networking (E); etc. The following equation can be utilized.

$$Cumulative Rating \text{:} ( 0.2 * A ) + ( 0.15 * B ) + ( 0.30 * C ) + ( 0.2 * D ) + ( 0.15 * E )$$

Each of these factors can be given weightage based on survey results. The ratings for the same are calculated based on a rating algorithm.

Returning to process 100, in step 104, process 100 can implement a future price calculation based on OBV Algorithm based on benchmarked vehicle. In step 106, process 100 can calculate the risk factor based on the following parameters, inter alia: vehicle segment performance (e.g. expected growth); competition space and future launches; probability of the vehicle model being discontinued; impact of policy changes on the vehicle; performance of OEMs; etc.

In step 108, process 100 can utilized the output of the previous steps to calculate the Buyback Value that can be offered. An example equation is: Future OBV Price*(1−Adjustment Factor Percentage).

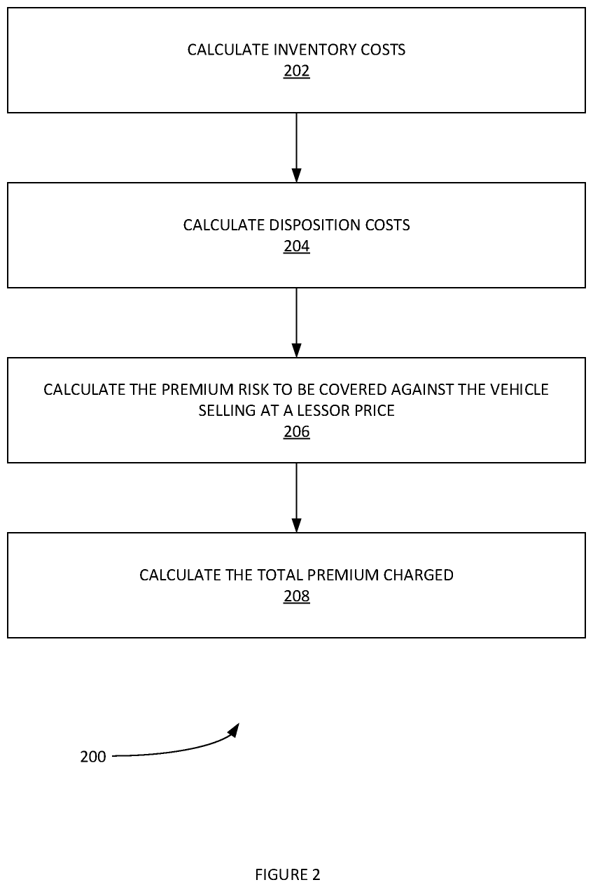

FIG. 2 illustrates an example process 200 for calculating the premium to be charged, according to some embodiments. The premium that is charged for offering buyback is a combination of three (3) costs: inventory cost, disposition cost, risk premium.

In step 202, process 200 can calculate inventory costs. These can be based on, inter alia: finance costs, holding costs, etc. In step 204, process 200 can calculate disposition costs. These can be based on, inter alia: RC transfer costs, certification costs, etc. In step 206, process 200 can calculate the premium risk to be covered against the vehicle selling at a lessor price (e.g. as a risk premium). It is noted that the premium is charged based on the following variable parameters after running a Monte-Carlo simulation. These can include, inter alia: number of vehicles sold; possible number of customers returning back; number of inventory days; etc. Based on the Monte Carlo simulation, the point at which the premium provides an eighty percent (80%) chance of profit is used as the premium. In step 208, process 200 can calculate the total premium charged. This can be the sum of the inventory costs, disposition costs and the risk premium.

Process 200 can consider other costs as well. These can include Finance Costs (FC). Average Finance cost based on the prevailing capital cost in the market is considered for the analysis. This cost is calculated based on the buyback value:

$$F C = B B V * ( 1 + ( Annual Interest Rate / 365 ) ) * Number of Inventory Days$$

These can include Parking Costs: (PC). Industry standards can be used for calculation of these costs. For example, a per vehicle per day the cost can be Rs.70 per day.

$$PC = Number of Inventory Days * 70$$

These can include Certification Cost (CC). In one example, a Certification Cost of 350 Rupees can be used for the four wheelers as the vehicle needs to be inspected before taking back the vehicle.

These can include RC Transfer Costs (RCC). The RC of the vehicle can be transferred at the time of ownership change and according to the market conditions around 2500 rupees is the cost involved for the RC Transfer in one example.

The premium for risk to be covered against vehicle selling at lesser price (RP) can be determine. The premium is charged based on the following variable parameters after running the Monte-Carlo simulation can be based on, inter alia: Number of Vehicles Sold; Possible number of Customers returning back; Number of Inventory Days; Selling Price Variation; etc.

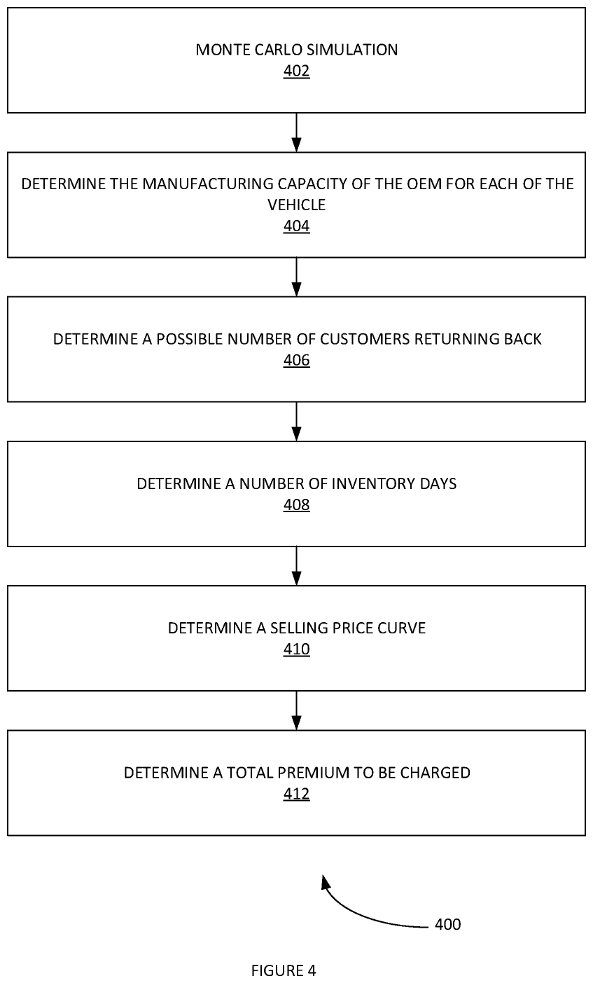

FIG. 4 illustrates an example process 400 for calculating a risk premium, according to some embodiments.

For calculating the risk premium, in step 402, process 400 runs a Monte Carlo simulation. Process 400 can include the following variables and costs, inter alia: distributions assumed for these variables; number of vehicles sold; etc.

Based on the segment which the vehicle is being launched, in step 404, process 400 determines the manufacturing capacity of the OEM for each of the vehicle. This can be the average number of vehicles which can be sold. For Example, for an MG Hector based on the market research and the average number of vehicles assumed to be 12000 per year.

In step 406, process 400 can determine a possible number of customers returning back. The customers returning back was fetched from the past data of the online vehicle sales platform's transactions. Of the total transactions at online vehicle sales platform the number of vehicles which are sold in first three years can be considered. In one example, based on this data and keeping the effect of Buyback program on number of customers returning the normal distribution with average of 50% coming back and variance of 7% was considered.

In step 408, process 400 can determine a number of inventory days. The number of days the car takes to sell was fetched from the past data of online vehicle sales platform's Transactions. Of the total transactions at online vehicle sales platform the number of vehicles which can be sold in first three years were considered and their average time to sell can be calculated. In one example, based on this data and keeping the effect of Buyback program on number of customers returning a right skewed distribution with average of 20 days' variance of 4 days was considered.

In step 410, process 400 can determine a selling price curve. A selling price curve was determined based on the total vehicles being sold and the demand in the market. In one example, a variation of 10% with mean of the buyback value obtained supra can be considered for the analysis.

Based on these parameters a Monte Carlo Simulation was run with all these parameters. The Premium charged was calculated based on the case where 80% of the cases were profitable. In step 412, process 400 can determine a total premium to be charged.

The total premium amount to be charged is the summation of

$$Premiumm = Inventory Cost ( IC ) + Disposition Cost ( DC ) + Risk Premium ( RP )$$

Additional Example Computer Architecture and Systems

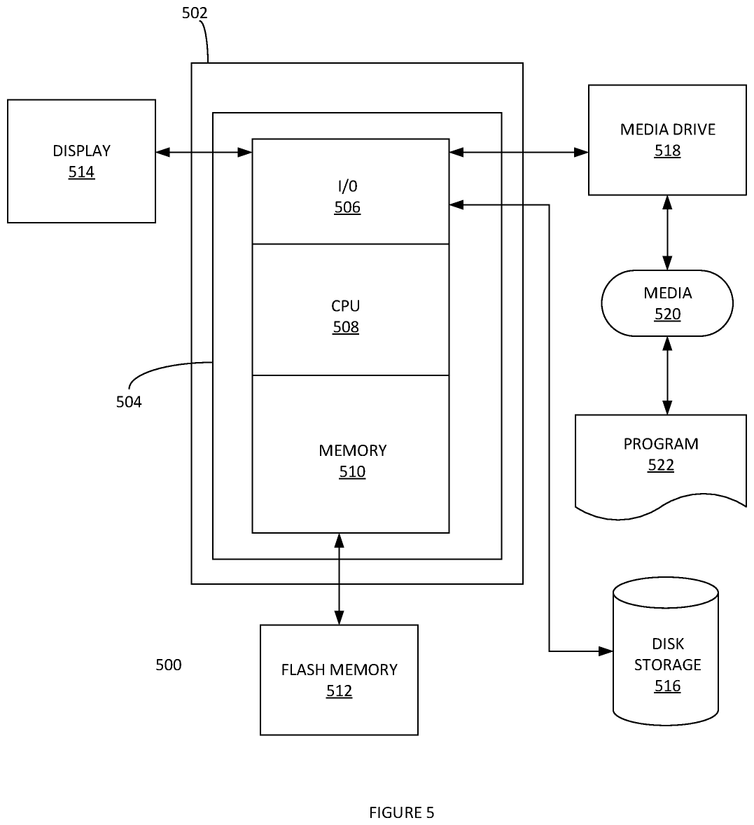

FIG. 5 depicts an exemplary computing system 500 that can be configured to perform any one of the processes provided herein. In this context, computing system 500 may include, for example, a processor, memory, storage, and I/O devices (e.g., monitor, keyboard, disk drive, Internet connection, etc.). However, computing system 500 may include circuitry or other specialized hardware for carrying out some or all aspects of the processes. In some operational settings, computing system 500 may be configured as a system that includes one or more units, each of which is configured to carry out some aspects of the processes either in software, hardware, or some combination thereof.

FIG. 5 depicts computing system 500 with a number of components that may be used to perform any of the processes described herein. The main system 502 includes a motherboard 504 having an I/O section 506, one or more central processing units (CPU) 508, and a memory section 510, which may have a flash memory card 512 related to it. The I/O section 506 can be connected to a display 514, a keyboard and/or other user input (not shown), a disk storage unit 516, and a media drive unit 518. The media drive unit 518 can read/write a computer-readable medium 520, which can contain programs 522 and/or data. Computing system 500 can include a web browser. Moreover, it is noted that computing system 500 can be configured to include additional systems in order to fulfill various functionalities. Computing system 500 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

Example Machine Learning Implementations

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alio: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression, and other tasks, which operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, which is a set of examples used to fit the parameters (e.g. weights of connections between neurons in artificial neural networks) of the model. The model (e.g. a neural net or a naïve Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. This procedure is complicated in practice by the fact that the validation dataset's error may fluctuate during training, producing multiple local minima. This complication has led to the creation of many ad-hoc rules for deciding when overfitting has truly begun. Finally, the test dataset is a dataset used to provide an unbiased evaluation of a final model fit on the training dataset. If the data in the test dataset has never been used in training (for example in cross-validation), the test dataset is also called a holdout dataset.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed:

1. A method for implementing a token transfer feature on an online vehicle sales platform comprising:
implementing a vehicle benchmarking;
implementing a future price calculation based on OBV Algorithm based on benchmarked vehicle;
calculating the risk factor based on the following parameters: vehicle segment performance, competition space and future launches, probability of the vehicle model being discontinued, impact of policy changes on the vehicle, and performance of OEMs; and
utilizing the risk factor and the vehicle benchmarking to calculate a Buyback Value to be offered.

2. The method of claim 1, wherein for an existing vehicle is benchmarked against a same vehicle in the market for previous years.

3. The method of claim 2, wherein the existing vehicle existing vehicle exists in the market.

4. The method of claim 1, wherein the vehicle benchmarking comprises benchmarking a new vehicle.

5. The method of claim 4, wherein the benchmarking of the new vehicle comprises:
implementing a segmentation of competitors;
calculating a cumulative score based on weightages of:
performance rating (A);
safety rating (B);
value for money rating (C);
demand rating (D); and
Service Networking (E).

6. The method of claim 5, wherein the calculation of the cumulative score is based on equation of:
$$Cumulative Rating \text{:} ( 0.2 * A ) + ( 0.15 * B ) + ( 0.30 * C ) + ( 0.2 * D ) + ( 0.15 * E )$$

7. The method of claim 6, wherein each of these factors is given weightage based on survey results.

8. The method of claim 6, wherein the ratings for the same are calculated based on a rating algorithm.

9. The method of claim 1, wherein the buyback value is calculating using:
Buyback value=Future OBV Price*(1−Adjustment Factor Percentage).
